(19) United States
(12) Patent Application Publication
(10) Pub. No.: US 2024/0211755 A1
(43) Pub. Date: Jun. 27, 2024

(54) METHOD OF PROVIDING ARTIFICIAL INTELLIGENCE ALGORITHM, OPERATING METHOD OF ARTIFICIAL INTELLIGENCE ALGORITHM, ELECTRONIC DEVICE, RECORDING MEDIUM, AND COMPUTER PROGRAM

(71) Applicant: Samsung Electronics Co., Ltd., Suwon-si (KR)

(72) Inventors: Sunghee LEE, Suwon-si (KR); QHwan KIM, Suwon-si (KR); Minkyu KIM, Suwon-si (KR); Bongseok KIM, Suwon-si (KR); Youngseok KIM, Suwon-si (KR); Ami MA, Suwon-si (KR); Jinkook PARK, Suwon-si (KR); Kyubaik CHANG, Suwon-si (KR); Jaehoon JEONG, Suwon-si (KR)

(73) Assignee: Samsung Electronics Co., Ltd., Suwon-si (KR)

(21) Appl. No.: 18/453,651

(22) Filed: Aug. 22, 2023

(30) Foreign Application Priority Data
Dec. 27, 2022 (KR) 10-2022-0186011

(51) Int. Cl. G06N 3/08

(52) U.S. Cl. CPC G06N 3/08

(57) ABSTRACT

Provided are a method of providing an artificial intelligence (AI) algorithm, an operation method of an AI algorithm, an electronic device, a recording medium, and a computer program. The method of providing the AI algorithm includes loading data sets with respect to a spectrum of a semiconductor and a structure of the semiconductor, calculating an out of distribution (OOD) index with respect to the spectrum of the semiconductor, performing data split by clustering sampling the data sets into at least one learning data set with respect to OOD indexes according to semiconductors, and providing an optimal AI algorithm from among a plurality of AI algorithms that have learned the at least one learning data set.

### CROSS-REFERENCE TO RELATED APPLICATION

This application claims priority under 35 U.S.C. § 119 to Korean Patent Application No. 10-2022-0186011, filed on Dec. 27, 2022, in the Korean Intellectual Property Office, the disclosure of which is incorporated by reference herein in its entirety.

### TECHNICAL FIELD

The present disclosure relates to an electronic device, and more particularly, to a method of providing an artificial intelligence (AI) algorithm, an operation method of an AI algorithm, an electronic device, a recording medium, and a computer program.

### DISCUSSION OF RELATED ART

Due to the reduction in size and the increase in complexity of semiconductor manufacturing processes, measurement of these processes is reaching its limit, making it very difficult to maintain measurement tools within the specifications required by strict process limits. Accuracy, process robustness, precision, matching, and other uncertainties related to measurement results are very difficult to achieve by using current methods.

Recently, a technology for predicting the structure of a semiconductor using an artificial intelligence (AI) algorithm has been actively researched. However, the structure of a semiconductor manufactured by high-aspect-ratio-contact (HARC) etching is complicated, which may incur a lot of cost and time to secure measurement data. In addition, when the number of data samples for structure prediction is small or the noise of data samples is large, even though the same model is used, overfitting of the AI algorithm may occur depending on data split conditions. Therefore, robust and consistent AI algorithms are required even with a small amount of data.

### SUMMARY

Embodiments of the present disclosure provide a method, an electronic device, a recording medium, and a computer program for preventing overfitting even with a small amount of data and providing a robust artificial intelligence (AI) algorithm.

According to an embodiment of the present disclosure, there is provided a method of providing an artificial intelligence (AI) algorithm including loading a first data set and a second data set, the first data set representing a spectrum of at least one semiconductor, and the second data set representing a structure of the at least one semiconductor; determining an out of distribution (OOD) index with respect to the spectrum of the semiconductor for each of the at least one semiconductor based on the first data set; performing a data split on the first data set and the second data set by cluster sampling the first data set and the second data set into at least one learning data set with respect to the OOD index according to the at least one semiconductor; and providing an optimal AI algorithm among a plurality of AI algorithms that have been trained on the at least one learning data set.

According to an embodiment of the present disclosure, there is provided an operation method of an artificial intelligence (AI) algorithm including receiving spectrum data indicating information of an actually measured spectrum of each of a plurality of semiconductors; generating a plurality of off of distribution (OOD) indexes by determining an OOD index for the spectrum of each of the plurality of semiconductors; predicting, from the spectrum data and using the AI algorithm, a structure of a semiconductor, of the plurality of semiconductors, when an OOD index of the semiconductor is smaller than a reference value for the AI algorithm; and providing an optimal AI algorithm, among a plurality of AI algorithms that have been trained, as the AI algorithm predicting the structure of the semiconductor when the OOD index of the semiconductor is greater than or equal to the reference value.

According to an embodiment of the present disclosure, there is provided an electronic device including a memory storing instructions for executing a method of providing an artificial intelligence (AI) algorithm and a processor configured to execute the instructions, wherein the processor is configured to, by executing the instructions, load a first data set and a second data set, the first data set representing a spectrum of at least one semiconductor, and the second data set representing a structure of the at least one semiconductor, determining an out of distribution (OOD) index with respect to the spectrum of the semiconductor for each of the least one semiconductor based on the first data set, perform a data split on the first data set and the second data set, by cluster sampling the first data set and the second data set into at least one learning data set with respect to the OOD index according to the at least one semiconductor, and provide an optimal AI algorithm among a plurality of AI algorithms that have been trained on the at least one learning data set.

According to embodiments of the present disclosure, there is provided non-transitory computer-readable storage medium storing computer program, which when executed by a computer, causes the computer to implement the embodiments.

### BRIEF DESCRIPTION OF THE DRAWINGS

Embodiments will be more clearly understood from the following detailed description taken in conjunction with the accompanying drawings in which:

FIG. 1 is a diagram illustrating a system according to some embodiments;

FIG. 2 is a flowchart illustrating an operation method of an artificial intelligence (AI) algorithm according to some embodiments;

FIG. 3 is a flowchart illustrating a method of providing an optimal AI algorithm according to some embodiments;

FIG. 4 is a flowchart illustrating an operation of calculating an out of distribution (OOD) index according to some embodiments;

FIG. 5 is a diagram illustrating a principal component analysis (PCA) map according to some embodiments;

FIG. 6 is a diagram illustrating a Euclidean distance and a cosine distance in the PCA map shown in FIG. 5;

FIG. 7 is a diagram illustrating an average value of a product of a Euclidean distance and a cosine distance for each semiconductor;

FIGS. 8A and 8B are diagrams illustrating correlations between an average value of a normalized OOD index according to wafers and various evaluation indicator errors of a specific predictive model;

FIG. 9 is a flowchart illustrating an operation of performing data split according to some embodiments;

FIGS. 10A, 10B, and 10C are diagrams illustrating an operation of cluster sampling data in descending order of OOD indexes according to at least one example embodiment;

FIGS. 11A, 11B, and 11C are diagrams illustrating an operation of cluster sampling data in ascending order of OOD indexes according to at least one embodiment;

FIGS. 12A and 12B are diagrams illustrating an operation of selecting an optimal algorithm according to some embodiments;

FIGS. 13A and 13B are diagrams illustrating an operation of selecting an optimal algorithm according to some embodiments;

FIG. 14 is a diagram illustrating an operation of selecting an optimal algorithm according to some embodiments; and

FIG. 15 is a conceptual diagram illustrating an operation method of a system according to some embodiments.

### DETAILED DESCRIPTION OF THE EMBODIMENTS

Hereinafter, embodiments of the present disclosure will be described in detail with reference to the accompanying drawings.

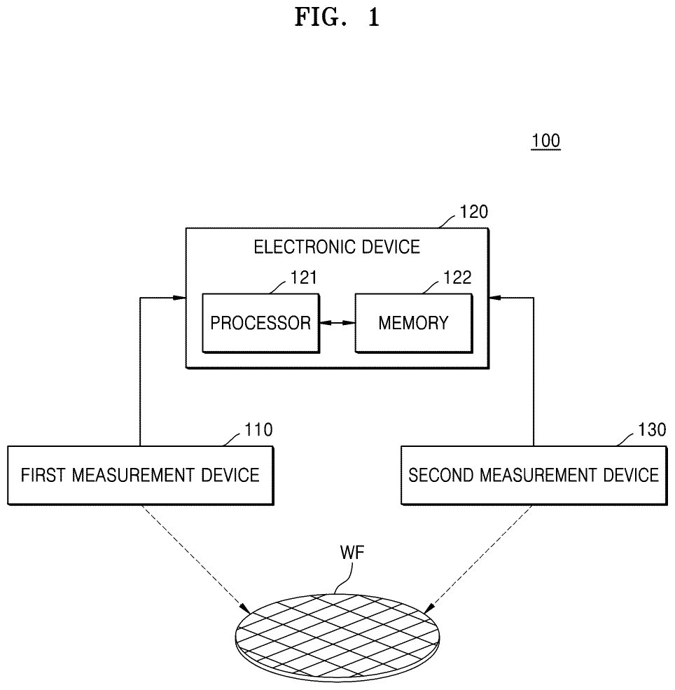

FIG. 1 is a diagram illustrating a system according to some embodiments.

Referring to FIG. 1, a system 100 may include a first measurement device 110, an electronic device 120, and a second measurement device 130.

The first measurement device 110 represents a device that actually measures the spectrum of a semiconductor WF. For example, the first measurement device 110 may radiate light to the semiconductor WF and provide spectrum data to the electronic device 120. Therefore, the spectrum data may represent information obtained by actually measuring the spectrum of the semiconductor WF. When there are a plurality of semiconductors WF, the first measurement device 110 may measure the spectrum of each semiconductor WF and provide the spectrum data of each semiconductor WF to the electronic device 120.

The semiconductor WF represents a semiconductor wafer, a semiconductor chip, semiconductor chips included in the semiconductor wafer, a semiconductor device included in the semiconductor chip, and/or the like. In at least some embodiments, the system 100 may include a stage (not illustrated) configured to seat the semiconductor WF and/or to maintain or adjust the position of the semiconductor WF based on the command signals of a controller (not illustrated).

The electronic device 120 corresponds to a computing device such as a server, a personal computer, a laptop computer, a portable communication terminal, a smart phone, and/or the like. For example, the electronic device may comprise processing circuitry such as hardware, software, or a combination of hardware and software. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The electronic device 120 may predict the structure of the semiconductor WF from the spectrum data using an artificial intelligence (AI) algorithm. An input of the AI algorithm may be a spectrum (e.g., spectrum data) of the semiconductor WF; and the output of the AI algorithm may be the predicted structure (e.g., structure data) of the semiconductor WF.

In some embodiments, the electronic device 120 may include a processor 121 and a memory 122.

The processor 121 may control the overall operation of the electronic device 120. For example, in at least one embodiment, the processor 121 has (and/or is configured to control) a structure that is trainable, e.g., with training data, such as an artificial neural network, a decision tree, a support vector machine, a Bayesian network, a genetic algorithm, and/or the like. Non-limiting examples of the trainable structure may include a convolution neural network (CNN), a generative adversarial network (GAN), an artificial neural network (ANN), a region based convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, and/or the like. The processor 121 may include an accelerator, for example, as a dedicated circuit for an AI data operation. The accelerator may be a functional block that specializes in performing a specific function of the processor 121. The accelerator may include (or be included in), for example, at least one of a graphics processing unit (GPU), a neural processing unit (NPU), a data processing unit (DPU), and/or the like. The GPU may be a block that specializes in processing graphics data. The NPU may be a block that specializes in performing AI calculation and inference. The DPU may be a block that specializes in data transmission. Hereinafter, for convenience of explanation, the processor 121 is implemented as an NPU configured to perform an operation method of an AI algorithm.

The processor 121 may execute instructions stored in the memory 122. In some embodiments, the instructions are for executing the operation method of the AI algorithm. In some embodiments, the processor 121 loads a first data set with respect to a spectrum of a semiconductor to be provided as input of the AI algorithm and a second data set with respect to a structure of a semiconductor to be output from the AI algorithm. Also, the processor 121 may calculate an out of distribution (OOD) index for the spectrum of each semiconductor based on the first data set. Also, in at least some embodiments, the processor 121 may perform data split on the first and second data sets by cluster sampling the first and second data sets as at least one learning data set based on the OOD index for each semiconductor. Also, the processor 121 may provide an AI algorithm, from among a plurality of AI algorithms that have been trained through the at least one learning data set, as an optimal AI algorithm, based on the OOD index of the optimal AI algorithm.

In some embodiments, the structure and/or predicted structure of the semiconductor may include, for example, Vertical NAND (V-NAND) Channel Hole critical dimension (CD) Profile, dynamic random access memory (DRAM) Shallow Trench Isolation (STI), DRAM Buried Channel Array Transistor (BCAT) Gate, DRAM BCAT Gate Buried Contact (GBC), DRAM BCAT Gate Bit Line (GBL), etc. However, the embodiments are not limited thereto.

The memory 122 may store instructions for executing an AI algorithm providing method. For example, the instructions for executing the AI algorithm providing method may be stored in the memory 122 as computer program codes.

In some embodiments, the memory 122 may be implemented as a non-volatile memory such as a read-only memory (ROM), magnetic RAM (MRAM), spin-transfer torque MRAM, conductive bridging RAM (CBRAM), ferroelectric RAM (FeRAM), phase RAM (PRAM), resistive RAM, etc. However, the embodiments are not limited thereto. In some embodiments, the memory 122 may include at least one of dynamic random-access memory (DRAM), synchronous DRAM (SDRAM), double data rate SDRAM (DDR SDRAM), low power double data rate SDRAM (LPDDR SDRAM), graphics double data rate SDRAM (GDDR SDRAM), DDR2 SDRAM, DDR3 SDRAM, DDR4 SDRAM, DDR5 SDRAM, etc.

The second measurement device 130 may be a device that actually measures the structure of the semiconductor WF. The second measurement device 130 may provide the electronic device 120 with structure measurement data representing actually measured information. In at least one embodiment, the second measurement device 130 may include an optical device configured to radiate light towards the semiconductor WF and detect light reflected therefrom, and/or an electron device configured to scan electron beams towards the semiconductor WF and to detect electrons emitted therefrom. For example, in at least some embodiments, the second measurement device 130 may include at least one of a scanning electron microscope (SEM), a transmission electron microscope (TEM), an electron beam inspection apparatus, and/or the like.

The electronic device 120 may use the structure measurement data to train an AI algorithm. For example, the electronic device 120 may train an AI algorithm with a data set including spectrum data and structure measurement data for the semiconductor WF. Therefore, in at least some embodiments, the AI algorithms may be trained based on unsupervised learning.

The electronic device 120 may be used as equipment predicting optical critical dimension (OCD) measurement, electron beam (e-beam) measurement, x-ray measurement, device characteristic measurement, etc.

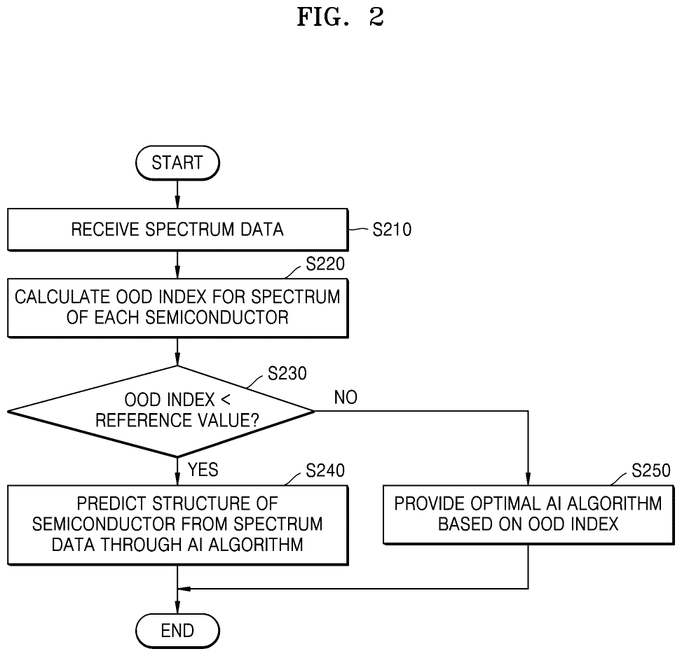

FIG. 2 is a flowchart illustrating an operation method of an AI algorithm according to some embodiments.

Referring to FIG. 2, the operation method of the AI algorithm shown in FIG. 2 may be performed by the electronic device 120 shown in FIG. 1. For example, the operation method may be stored in the memory 122 as instructions, and executed by processing circuitry in the electronic device 120.

An operation of receiving spectrum data is performed (S210). The spectrum data may be data representing information of an actually measured spectrum of each semiconductor. Referring to FIG. 1, for example, the processor 121 may receive the spectrum data from the first measurement device 110.

An operation of calculating an OOD index for the spectrum of each semiconductor is performed (S220). When semiconductors corresponding to a prediction target are plural, the OOD index for the spectrum of the semiconductor may be calculated for each semiconductor. Referring to FIG. 1, for example, the processor 121 may calculate the OOD index based on the spectrum data. The OOD index may represent the distribution of data having a distribution different from the distribution of learning data used to train the AI algorithm. The OOD index for the spectrum of the semiconductor according to Embodiments of the present disclosure may represent the distribution of spectrum data in a learning area of the AI algorithm. When the OOD index for the spectrum of the semiconductor is included within the learning area, the probability that the AI algorithm accurately predicts the structure of the semiconductor may be relatively high. On the other hand, when the OOD index for the spectrum of the semiconductor is outside the learning area, the probability that the AI algorithm accurately predicts the structure of the semiconductor may be relatively low.

An operation of comparing the OOD index to a reference value is performed (S230). When the OOD index is relatively small, the structure of the semiconductor WF may be predicted from the spectrum data using only an AI algorithm currently installed in the electronic device 120. Meanwhile, when the OOD index is relatively large, the structure of the semiconductor WF may not be accurately predicted by the AI algorithm currently provided in the electronic device 120. In these cases, an optimal AI algorithm may be selected. Therefore, operation S230 may be used for determining whether an operation for updating the AI algorithm is to be performed. In some embodiments, the reference value may be “1”, but is not limited thereto.

When the OOD index is less than the reference value (S230, Yes), an operation of predicting a structure of the semiconductor from the spectrum data through the AI algorithm is performed (S240). For example, a structure of a semiconductor having an OOD index less than the reference value among a plurality of OOD indexes may be predicted from the spectrum data through the AI algorithm. Referring to FIG. 1, for example, the processor 121 may predict the structure of the semiconductor WF from the spectrum data through the AI algorithm.

When the OOD index is greater than the reference value (S230, No), an operation of providing the optimal AI algorithm based on the OOD index is performed (S250), and the structure of the semiconductor may be predicted using the optimal AI algorithm. For example, the optimal AI algorithm represents the most excellent (e.g., the most accurate) performance among a plurality of AI algorithms that have been trained through a data set may be provided. Referring to FIG. 1, for example, the processor 121 may configure the spectrum data and the structure measurement data as a learning data set, train the learning data set on each of a plurality of AI algorithms, and provide the optimal AI algorithm having the most excellent performance among the plurality of AI algorithms that have been trained.

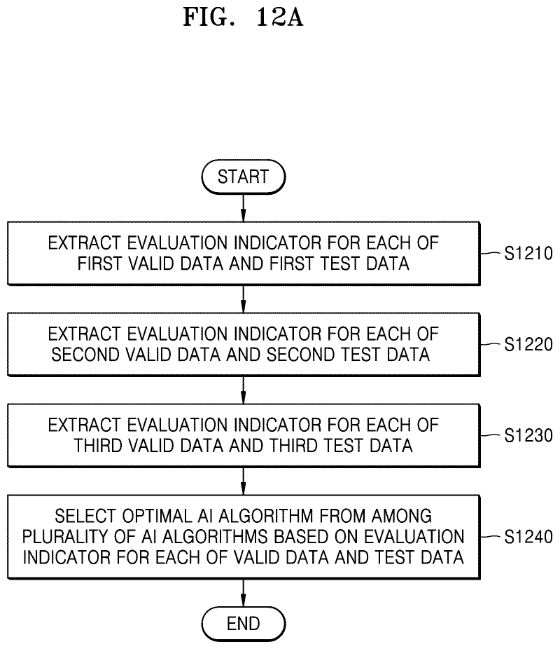

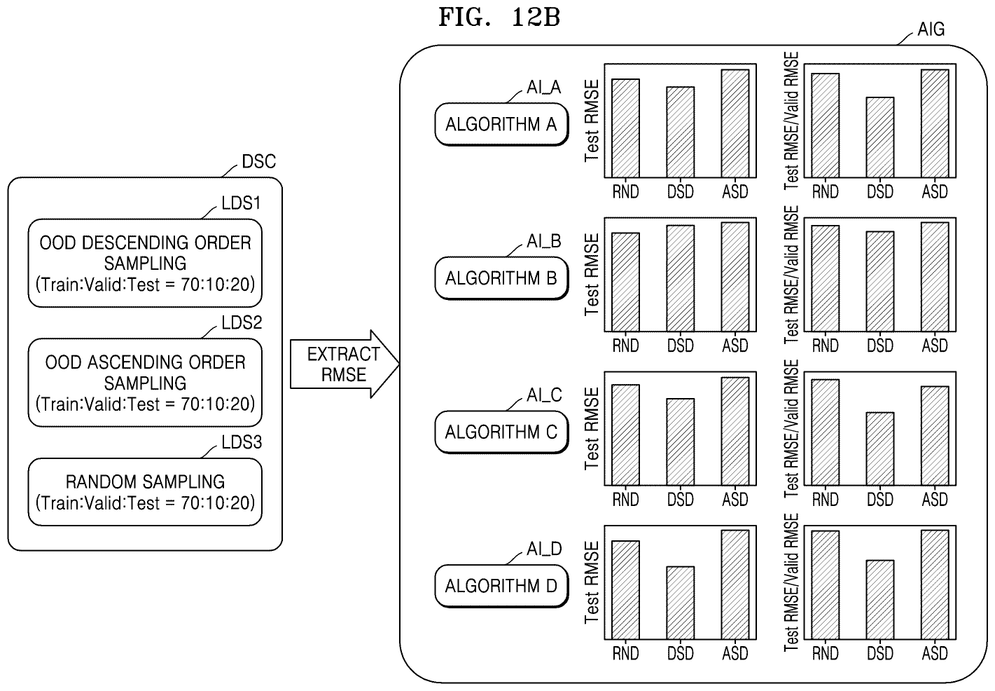

In some embodiments, the optimal AI algorithm may be selected using an OOD index greater than or equal to the reference value from among the plurality of AI algorithms that have learned a data set with respect to the existing semiconductor. At least one embodiment relating to an operation of selecting the optimal AI algorithm is described below with reference to FIGS. 12A to 14.

In some embodiments, the plurality of AI algorithms may be trained (or learn) based a first data set including spectrum data of a semiconductor and a second data set including structure measurement data. The data sets used to train the plurality of AI algorithms may also be referred to as training data sets or learning data sets. Here, the structure measurement data may represent information of actually measured structures of semiconductors each having a plurality of OOD indexes by a measurement device (e.g., the second measurement device 130). For example, the structure measurement data may include information of an actually measured structure of the existing semiconductor and information of an actually measured structure of a new semiconductor. Here, an OOD index of the new semiconductor may be greater than or equal to that of the reference value. Referring to FIG. 1, for example, the processor 121 may receive structure measurement data from the second measurement device 130.

As described above, the cost and the time required to train an AI algorithm are reduced, by preventing overfitting even with a small amount of data and providing a robust AI algorithm.

In addition, as described above, the time (e.g., the turn-around time (TAT)) required to secure the consistency of the AI algorithm with respect to, e.g., a complex semiconductor structure is reduced, and the cost required to train the AI algorithm according to the frequent revision of process is reduced.

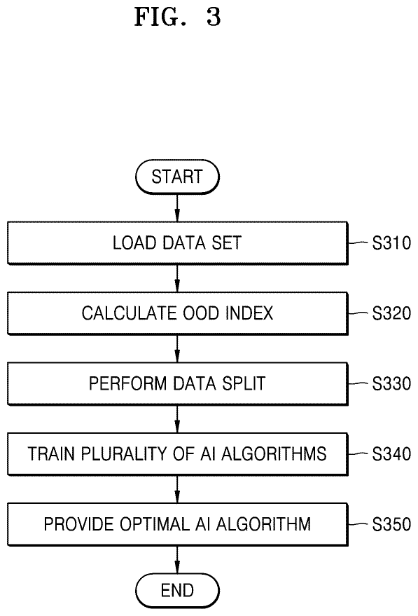

FIG. 3 is a flowchart illustrating a method of providing an optimal AI algorithm according to some embodiments.

Referring to FIG. 3, the method shown in FIG. 3 may correspond to operation S260 shown in FIG. 2. Alternatively, the method shown in FIG. 3 may be performed by the electronic device 120 shown in FIG. 1 separately from the method shown in FIG. 2.

An operation of loading a data set is performed (S310). For example, in at least one embodiment, a first data set and a second data set are loaded into the electronic device 120. The first data set may include data with respect to the spectrum of a semiconductor to be provided as an input of an AI algorithm. For example, the first data set may include spectrum data of each semiconductor. The second data set may include data with respect to the structure of a semiconductor to be output from an AI algorithm. For example, the second data set may include structure measurement data of each semiconductor.

An operation of calculating an OOD index is performed (S320). For example, in at least one embodiment, based on the first data set, an operation of calculating the OOD index for the spectrum of each semiconductor is performed. Accordingly, a plurality of OOD indexes may be calculated.

An operation of performing data split is performed (S330). The data split may be an operation of sampling loaded data sets as a learning data set. In some embodiments, the data split may classify loaded data sets into a training group, a valid group, and a test group of the learning data set. The training group may include spectrum data and structure measurement data, and the test group may include spectrum data. The ratio between the training group, the valid group, and the test group may be set in various ways. For example, the ratio between the training group, the valid group, and the test group may be “70(%):10(%):20(%)”. However, the embodiments are not limited thereto, and the total ratio of the training group, the valid group, and the test group may be 100%, and the ratio of each group may be set in various ways. Hereinafter, for convenience of explanation, it is assumed that the ratio of the training group, the valid group, and the test group is “70:10:20”.

The learning data set of the present disclosure may be at least one type. Each of two or more learning data sets may be classified according to different sampling methods. For example, in at least some embodiments, each learning data set may be selected to represent a type of structure.

In some embodiments, operation S330 of performing data split on the first and second data sets is performed, by clustering sampling the first and second data sets as at least one learning data set with respect to an OOD index for each semiconductor.

An operation of training a plurality of AI algorithms using the at least one learning data set is performed (S340).

An operation of providing an optimal AI algorithm among the plurality of AI algorithms that have been trained through the at least one learning data set is performed (S350).

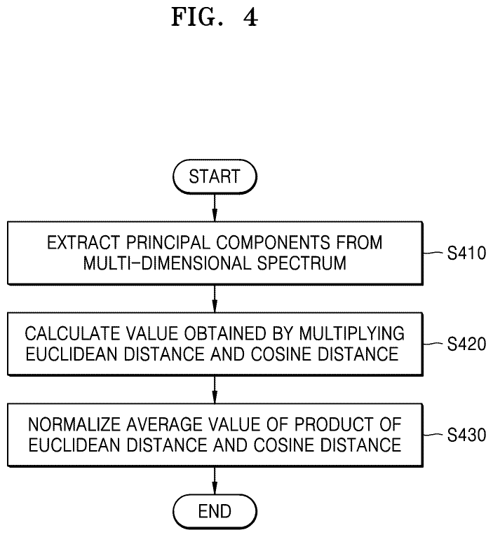

FIG. 4 is a flowchart illustrating an operation of calculating an OOD index according to some embodiments.

Referring to FIG. 4, an operation of calculating one or more OOD indexes may include operations S410, S420, and S430. The operations of FIG. 4 are provided as an example of operations corresponding to, e.g., operation S320 of FIG. 3.

An operation of extracting principal components from a multi-dimensional spectrum is performed (S410). In the case of spectrum data included in a first data set, the number of spectrum dimensions may be very large, for example, about 1000. As the number of dimensions of the spectrum increases (or the dimension of the spectrum becomes more complex), it may be difficult to predict the structure of a semiconductor from the spectrum of the semiconductor through an AI algorithm. Therefore, to increase the probability of predicting the structure of a semiconductor, it is beneficial to extract some principal components from the multi-dimensional spectrum.

In some embodiments, operation S410 of extracting first and second two-dimensional principal components of the first data set for each semiconductor is performed, by performing principal component analysis (PCA) to reduce the dimension of the first data set.

An operation of calculating a value obtained by multiplying a Euclidean distance between vectors including first and second principal components and a cosine distance between the vectors and the origin for each semiconductor is performed based on the vectors (S420).

An operation of extracting a normalized value as the OOD index for each semiconductor by normalizing an average value of the product of the Euclidean distance and the cosine distance for each semiconductor is performed (S430).

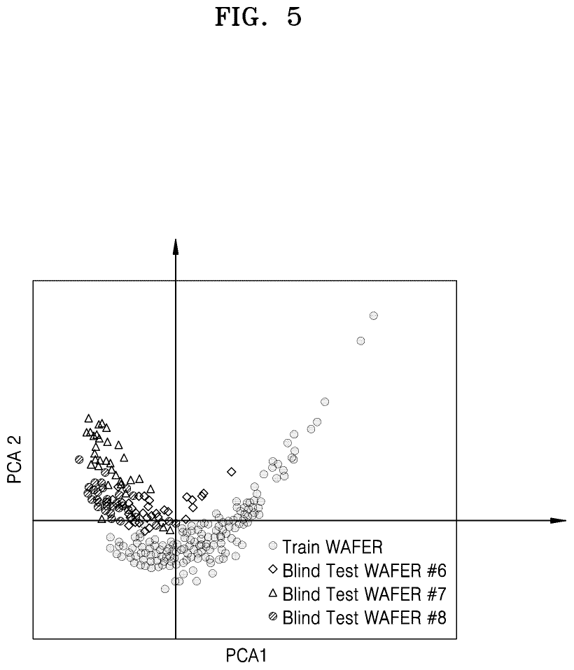

FIG. 5 is a diagram illustrating a PCA map according to some embodiments.

In some embodiments, a learning data set may be classified into a training group, a valid group, and a test group. The training group of the present disclosure is referred to or shown in the drawings as “Train”, the valid group is referred to or shown in the drawings as “Valid”, and the test group is referred to or shown in the drawings as “Blind Test” (or “Test”). Meanwhile, a semiconductor (e.g., a semiconductor WF shown in FIG. 1) is referred to as a wafer.

Referring to FIGS. 4 and 5, points representing a “train wafer” shown in FIG. 5 are vectors including first and second principal components PCA1 and PCA2 of the spectrum included in the training group of the learning data set. In this regard, the points representing the “train wafer” shown in FIG. 5 may be vectors including the first and second principal components PCA1 and PCA2 of the spectrum of one or more wafers. Points representing a “blind test wafer” shown in FIG. 5 are vectors including the first and second principal components PCA1 and PCA2 of spectrum data included in the test group of the learning data set. In this regard, “#6”, “#7”, and “#8” shown in FIG. 5 may be numbers or identification of wafers to be blind tested. It is assumed in FIG. 5 that wafers to be blind tested are numbered 6, 7, and 8.

Due to the structure, nature, manufacturing process, etc., of the wafer, actual measurement of the spectrum of one wafer may not be consistent. Alternatively, the spectrum may be different for each location to be actually measured within one wafer due to the number of semiconductor chips included in one wafer, the shape of the wafer, etc. Accordingly, the vectors including the first and second principal components PCA1 and PCA2 of the spectrum may be dispersed. For example, vectors corresponding to “Train wafer”, vectors corresponding to “Blind test wafer #6”, vectors corresponding to “Blind test wafer #7”, and vectors corresponding to “Blind test wafer #8” may be distributed as shown in FIG. 5.

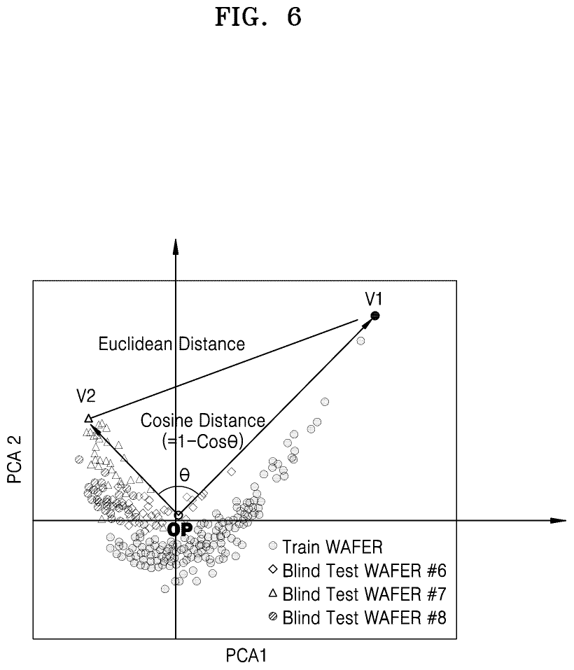

FIG. 6 is a diagram illustrating a Euclidean distance and a cosine distance in the PCA map shown in FIG. 5.

Referring to FIGS. 4, 5, and 6, the Euclidean distance between vectors corresponding to “Train wafer”, vectors corresponding to “Blind test wafer #6”, vectors corresponding to “Blind test wafer #7”, and vectors corresponding to “blind test wafer #8” may be calculated. For example, the Euclidean distance between a first vector V1 corresponding to “Train wafer” and a second vector V2 corresponding to “Blind test wafer #7” may be calculated.

Meanwhile, the cosine distance between the vectors corresponding to “Train wafer”, the vectors corresponding to “Blind test wafer #6”, the vectors corresponding to “Blind test wafer #7”, and the vectors corresponding to “Blind test wafer #8” may be calculated. For example, the cosine distance between the first vector V1, the second vector V2, and an origin OP may be calculated as shown in [Equation 1] below.

$$Cosine Distance = 1 - cos θ \qquad [ Equation 1 ]$$

Here, θ is an angle between the first vector V1, the second vector V2, and the origin OP.

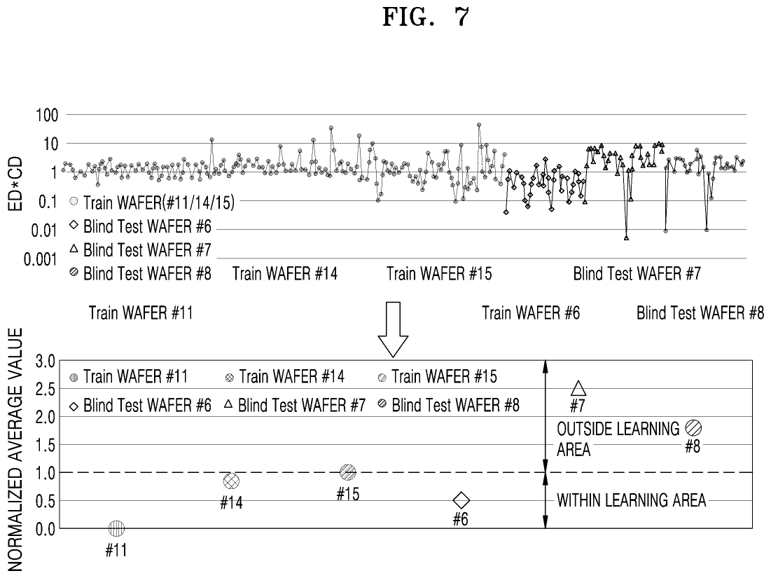

FIG. 7 is a diagram illustrating an average value of a product of a Euclidean distance and a cosine distance for each semiconductor.

Referring to FIGS. 4, 6, and 7, “Train Wafer #11”, “Train Wafer #14”, and “Train Wafer #15” correspond to the “Train Wafer” shown in FIG. 6, and may be wafers included in a training group (“Train” shown in FIG. 7). Also, “#11”, “#14”, and “#15” represent wafer numbers belonging to a training group (“Train” shown in FIG. 7). “Blind test wafer #6”, “Blind test wafer #7”, and “Blind test wafer #8” may be wafers included in a test group (“Blind Test” shown in FIG. 7).

With respect to each of “Train wafer #11”, “Train wafer #14”, “Train wafer #15”, “Blind test wafer #6”, “Blind test wafer #7”, and “Blind test wafer #8”, the product (ED*CD) of the Euclidean distance and the cosine distance may be calculated and shown as in FIG. 7. At this time, the value of the product (ED*CD) shown in FIG. 7 is an example.

For easy interpretation and analysis of users such as designers, evaluators, and engineers, the average value of the product (ED*CD) of the Euclidean distance and the cosine distance with respect to each wafer shown in FIG. 7 may be calculated for each wafer, and the average value with respect to each wafer may be normalized. The normalized average value may be extracted as an OOD index with respect to the spectrum.

“Train Wafer #11”, “Train Wafer #14”, and “Train Wafer #15” included in the training group (“Train” shown in FIG. 7) are used for training of the AI algorithm, and thus, their normalized average values may be included within a learning area. The learning area of the present disclosure may be in a range, for example, between 0 and 1.

On the other hand, in the case of a test group (“Blind Test” shown in FIG. 7), their normalized average values may be included within the learning area or included outside the learning area. For example, the normalized average value of “Blind test wafer #6” may be included within the learning area, the normalized average value of “Blind test wafer #7” and the normalized average value of “Blind test wafer #8” may be included outside the learning area. However, embodiments are not limited thereto.

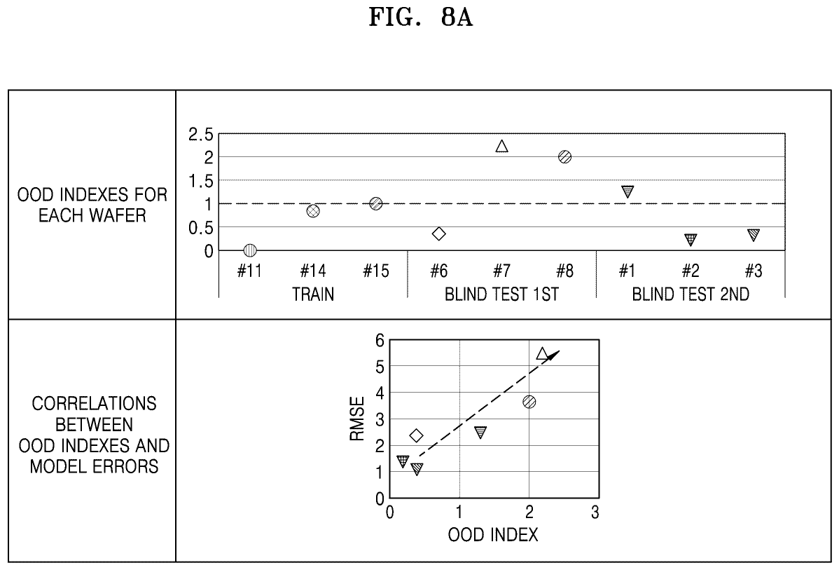

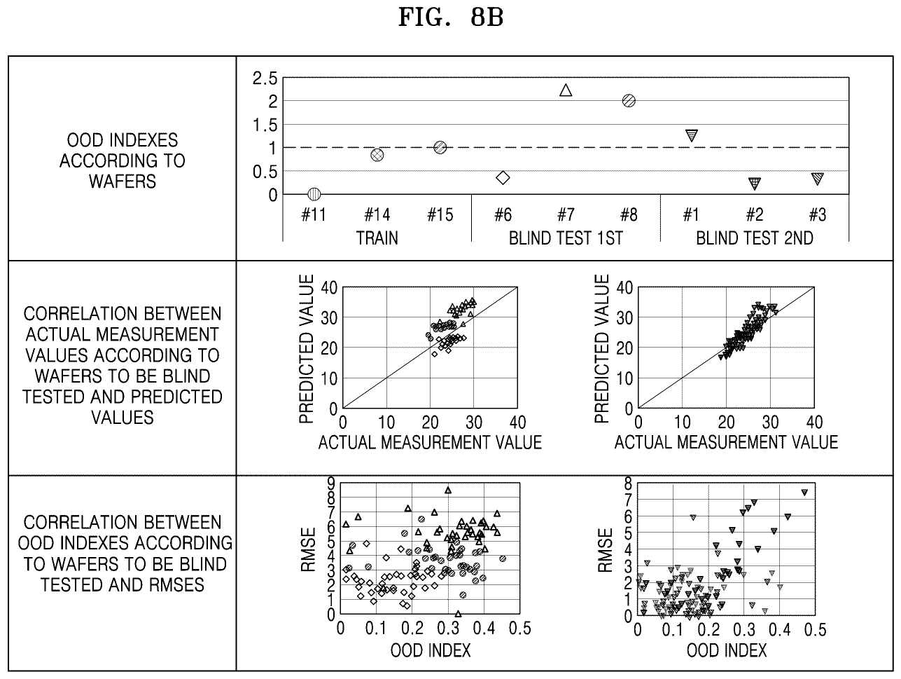

FIGS. 8A and 8B are diagrams illustrating correlations between an average value of a normalized OOD index according to wafers and various evaluation indicator errors of a specific predictive model. FIG. 8A shows the correlation between the normalized OOD index according to wafers and model errors, and FIG. 8B shows the correlations between actual measurement values according to wafers to be blind tested and predicted values, and the correlations between OOD indexes according to wafers to be blind tested and predicted values of root mean square error (RMSE).

Referring to FIG. 8A, the OOD index for each wafer included in a training group (“Train” shown in FIG. 8A) may be extracted as a normalized average value. The OOD index for each wafer included in the training group (“Train” shown in FIG. 8A) may be included in a learning range (e.g., a range equal to or greater than 0 to equal to or less than 1).

Meanwhile, the OOD indexes for each wafer included in test groups (“Blind Test 1st” and “Blind Test 2nd” shown in FIG. 8A) may also be extracted as normalized average values. Here, some wafers (e.g., “#6”, “#2”, and “#3” shown in FIG. 8A) may be included in the learning range, and some wafers (e.g., “#7”, “#8”, and “#1” shown in FIG. 8A) may not be included in the learning range.

As the OOD indexes with respect to the test groups (“Blind Test 1st” and “Blind Test 2nd” shown in FIG. 8A) increase, the model errors may tend to increase. As the OOD indexes with respect to the test groups (“Blind Test 1st” and “Blind Test 2nd” shown in FIG. 8A) decrease, the model errors may tend to decrease. Here, the model error may be represented by various evaluation indicators of AI algorithms. The evaluation indicators may include, for example, a root-mean-square error (RMSE), a Mean Absolute Error (MAE), a Mean Squared Error (MSE), a Mean Absolute Percentage Error (MAPE), a Mean Percentage Error (MPE), an R2 score (or an R squared), and/or the like. According to this, the predictability of the AI algorithm may be confirmed through the OOD index. In the following, it is assumed that the evaluation indicator is the RMSE.

Referring to FIG. 8B, in the case of a wafer (e.g., “#6” shown in FIG. 8B) having the OOD index included in the learning range in the first test group (“Blind Test 1st” shown in FIG. 8B), because points representing the actual measurement value and the predicted value of structure measurement of the wafer are located very close to each other on a straight line, the actual measurement value and the predicted value may tend to relatively coincide with each other. On the other hand, in the case of wafers (e.g., “#7” and “#8” shown in FIG. 8B) having the OOD index excluded from the learning range in the first test group (“Blind Test 1st” shown in FIG. 8B), because points representing the actual measurement value and the predicted value of structure measurement of the wafer are located far from a straight line, the actual measurement value and the predicted value may tend not to relatively coincide with each other.

In the case of wafers (e.g., “#2” and “#3” shown in FIG. 8B) having the OOD index included in the learning range in the second test group (“Blind Test 2nd” shown in FIG. 8B), the points representing the actual measurement value and the predicted value of structure measurement of the wafer may be located very close to each other on a straight line. On the other hand, in the case of a wafer (e.g., “#1” shown in FIG. 8B) having the OOD index excluded from the learning range in the second test group (“Blind Test 2nd” shown in FIG. 8B), the points representing the actual measurement value and the predicted value of structure measurement of the wafer may be located far from the straight line.

In the case of a wafer (e.g., “#6” shown in FIG. 8B) having the OOD index included in the learning range in the first test group (“Blind Test 1st” shown in FIG. 8B), the OOD index and the RMSE may be relatively small. Accordingly, prediction through an AI algorithm may be facilitated. On the other hand, in the case of wafers (e.g., “#7” and “#8” shown in FIG. 8B) having the OOD index excluded from the learning range in the first test group (“Blind Test 1st” shown in FIG. 8B), the OOD index and the RMSE may be relatively large. Accordingly, prediction through an AI algorithm may be difficult.

In the case of wafers (e.g., “#2” and “#3” shown in FIG. 8B) having the OOD index included in the learning range in the second test group (“Blind Test 2nd” shown in FIG. 8B), the OOD index and the RMSE may be relatively small. On the other hand, in the case of a wafer (e.g., “#1” shown in FIG. 8B) having the OOD index excluded from the learning range in the second test group (“Blind Test 2nd” shown in FIG. 8B), the OOD index and the RMSE may be relatively large.

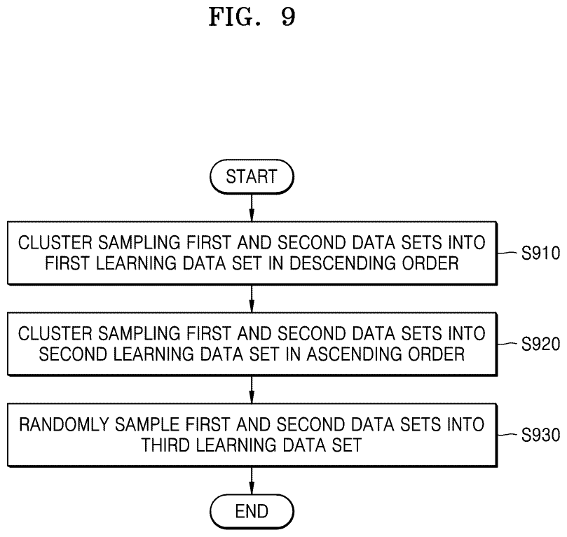

FIG. 9 is a flowchart illustrating an operation of performing data split according to some embodiments.

The data split shown in FIG. 9 may be performed to generate a learning model and verify the learning model. The operation of performing the data split shown in FIG. 9 may correspond to operation S330 shown in FIG. 3. In some embodiments, the operation of performing the data split may include sequentially sampling first and second data sets at a preset ratio into a training group, a valid group, and a test group of each allocated learning data set according to OOD indexes according to semiconductors.

Referring to FIG. 9, an operation of cluster sampling the first and second data sets into a first learning data set in descending order is performed (S910). Specifically, for example, the first and second data sets may be sampled into a training group, a valid group, and a test group of the first learning data set in descending order of decreasing OOD indexes according to semiconductors.

An operation of cluster sampling the first and second data sets into a second learning data set in ascending order is performed (S920). Specifically, for example, the first and second data sets may be sampled into a training group, a valid group, and a test group of the second learning data set in ascending order of increasing OOD indexes according to semiconductors.

An operation of randomly sampling the first and second data sets into a third learning data set is performed (S930).

According to at least one embodiment, operations S910 and/or operation S920 may be performed and operation S930 may be omitted. For example, only operation S910 may be performed in at least one embodiment, only operation S920 may be performed in another embodiment, and only operations S910 and S920 may be performed in another embodiment.

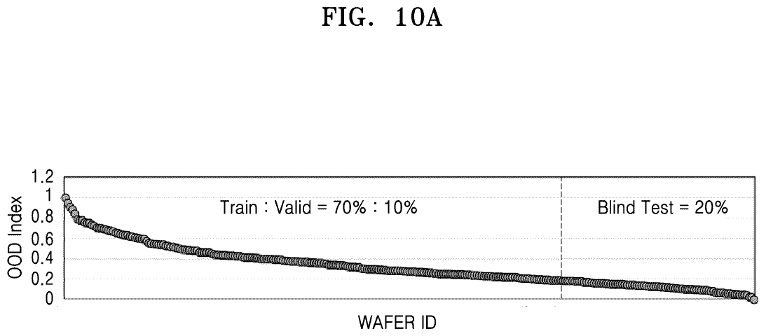

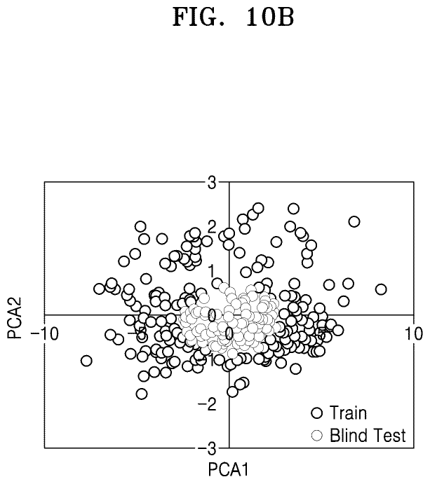

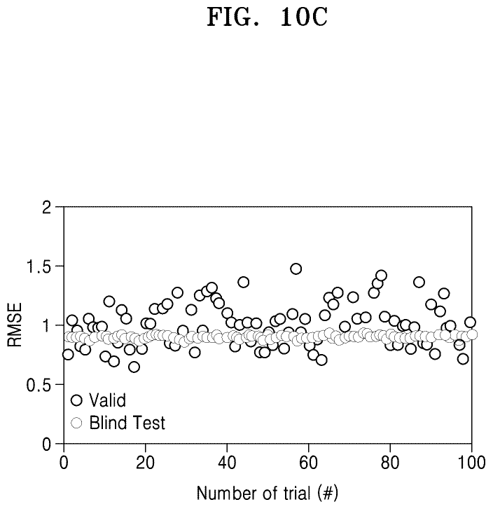

FIGS. 10A, 10B, and 10C are diagrams illustrating an operation of cluster sampling data in descending order of OOD indexes according to at least one embodiment.

In the graph shown in FIG. 10A, the horizontal axis represents wafer identification (ID), and the vertical axis represents OOD indexes with respect to the spectrum. In some embodiments, first and second data sets may be sampled into a training group, a valid group, and a test group of a learning data set in descending order of decreasing OOD indexes for each semiconductor. Referring to FIG. 10A, for example, from a wafer having the largest OOD index to a wafer having a certain OOD index, spectrum data and structure measurement data of a corresponding wafer may be classified into a training group and a valid group. In this regard, the ratio of the training group and the valid group may be set to 70(%):10(%). For example, about 80% of the first and second data sets may be classified into a training group and a valid group. 20% of the first and second data sets that are not classified into the training group and the valid group may be classified into the test group (or a blind test group).

Referring to FIG. 10B, in the PCA map shown in FIG. 10B, vectors (e.g., points shown in FIG. 10B) of data sets (“Blind Test” shown in FIG. 10B) classified into a test group may be located close to the origin (e.g., a point where the first and second principal components PCA1 and PCA2 are 0). Meanwhile, vectors of data sets (“Train” shown in FIG. 10B) classified into train and valid groups may be dispersed far from the origin.

Referring to FIG. 10C, the graph shown in FIG. 10C represents an RMSE with respect to the number of trials of learning. Despite the relatively small number of trials of learning, the RMSE with respect to the data sets (“Blind Test” shown in FIG. 10C) classified into the test group may have a relatively low value (e.g., a value smaller than 1). According to this, an AI algorithm of relatively low overfitting may be derived with a relatively small number of trials of learning, by performing data split of cluster sampling the first and second data sets in descending order of the OOD indexes. In other words, the overfitting of the AI algorithm may be adjusted (or controlled) even with a relatively small number of trials of learning. In addition, the cost and the time are saved by reducing the number of trials of learning to logically align the data sets.

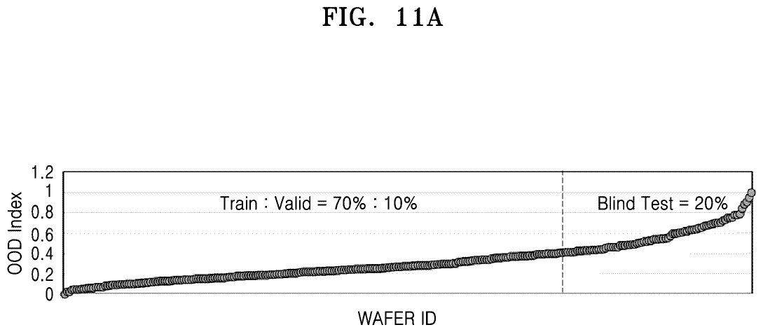

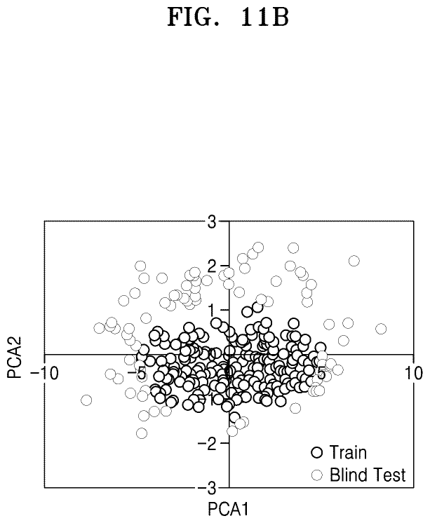

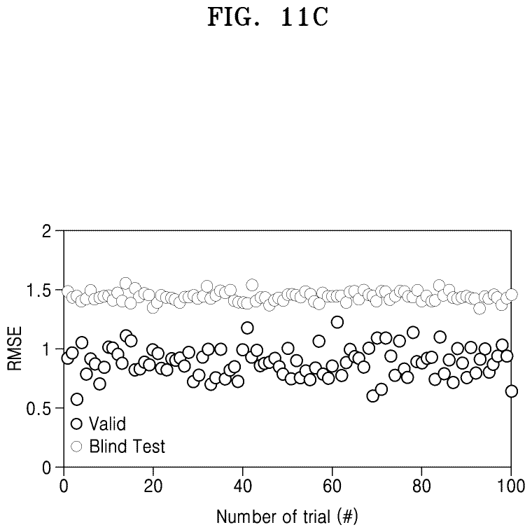

FIGS. 11A, 11B, and 11C are diagrams illustrating an operation of cluster sampling data in ascending order of OOD indexes according to at least one embodiment.

In the graph shown in FIG. 11A, the horizontal axis represents the wafer ID and the vertical axis represents the OOD indexes with respect to the spectrum. In some embodiments, first and second data sets may be sampled into a training group, a valid group, and a test group of a learning data set in an ascending order of increasing OOD indexes for each semiconductor. Referring to FIG. 11A, for example, about 80% of the first and second data sets, from a wafer having the smallest OOD index to a wafer having a certain OOD index, may be classified into a training group and a valid group. About 20% of all of the first and second data sets, from a wafer having a certain OOD index to a wafer having the largest OOD index, may be classified into a test group.

Referring to FIG. 11B, in the PCA map shown in FIG. 11B, vectors (e.g., points shown in FIG. 11B) of data sets (“Blind Test” shown in FIG. 11B) classified into a test group may be dispersed far from the origin (e.g., a point where the first and second principal components PCA1 and PCA2 are 0). Meanwhile, vectors of data sets (“Train” shown in FIG. 11B) classified into train and valid groups may be located close to the origin.

Referring to FIG. 11C, the graph shown in FIG. 11C represents an RMSE with respect to the number of trials of learning. Despite the relatively small number of trials of learning, the RMSE with respect to the data sets (“Blind Test” shown in FIG. 11C) classified into the test group may have a relatively high value (e.g., a value greater than 1). According to this, an AI algorithm of relatively high overfitting may be derived with a relatively small number of trials of learning, by performing data split of cluster sampling the first and second data sets in ascending order of the OOD indexes. In other words, the overfitting of the AI algorithm may be adjusted (or controlled) even with a relatively small number of trials of learning. In addition, the cost and the time are saved by reducing the number of trials of learning to logically align the data sets.

On the other hand, according to the data split of randomly sampling the data set, there are cases where it is difficult to control the overfitting of the AI algorithm even when a relatively large number of trials of learning is performed. Therefore, according to the cluster sampling according to the order of the OOD indexes of the present disclosure, a robust AI algorithm may be provided.

FIGS. 12A and 12B are diagrams illustrating an operation of selecting an optimal algorithm according to some embodiments.

Referring to FIGS. 9 and 12A, an operation of extracting an evaluation indicator for each of first valid data and first test data is performed (S1210). The first valid data may be data included in a valid group of the first learning data set of FIG. 9. For example, the first valid data may be classified into a valid group of first learning data set in the first and second data sets. The first test data may be data included in a test group of the first learning data set of FIG. 9. For example, the first test data may be classified into the test group of the first learning data set in the first and second data sets. The first learning data set of FIG. 9 may be obtained by cluster sampling the first and second data sets in descending order of OOD indexes.

In some embodiments, the evaluation indicator may be an RMSE. As a specific example, in operation S1210, the first valid data and the first test data are applied to each of a plurality of AI algorithms, so that an RMSE for the first valid data and an RMSE for the first test data may be extracted from each of the plurality of AI algorithms. In some embodiments, the evaluation indicator may include an MAE, an MSE, an MAPE, an MPE, and/or an R2 score.

An operation of extracting an evaluation indicator for each of second valid data and second test data is performed (S1220). The second valid data may be classified into a valid group of the second learning data set of FIG. 9 in the first and second data sets. The second test data may be classified into a test group of the second learning data set of FIG. 9 from the first and second data sets. The second learning data set of FIG. 9 may be cluster sampling of the first and second data sets in ascending order of OOD indexes.

In some embodiments, the evaluation indicator may be an RMSE. As a specific example, in operation S1220, an RMSE for the second valid data and an RMSE for the second test data may be extracted from each of the plurality of AI algorithms by applying the second valid data and the second test data to each of the plurality of AI algorithms, though the examples are not limited thereto.

An operation of extracting an evaluation indicator for each of third valid data and third test data is performed (S1230). The third valid data may be data classified as a valid group of the third learning data set of FIG. 9. The third test data may be data classified as a test group of the third learning data set of FIG. 9. The third learning data set of FIG. 9 may be obtained by randomly sampling the first and third data sets.

An operation of selecting the optimal AI algorithm from among the plurality of AI algorithms based on the evaluation indicator for each of the valid data and the test data is performed (S1240). In some embodiments, when the evaluation indicator is the RMSE, the optimal AI algorithm may be selected from among the plurality of AI algorithms based on the RMSE for the first valid data, the RMSE for the first test data, the RMSE for the second valid data, and the RMSE for the second test data. Operation S1240 is described below with reference to FIG. 12B.

In some embodiments, the optimal AI algorithm may be at least one of a plurality of AI algorithms. For example, the optimal AI algorithm may be one AI algorithm having the most excellent performance among the plurality of AI algorithms. In another example, one AI algorithm having the most excellent performance within a learning area from among a plurality of AI algorithms may be selected as the optimal AI algorithm within the learning area, and among the plurality of AI algorithms, and one AI algorithm having the most excellent performance outside the learning area from among the plurality of AI algorithms may be selected as the optimal AI algorithm within the learning area.

Referring to FIGS. 9 and 12B, a data split condition DSC may include a first learning data set LDS1, a second learning data set LDS2, and a third learning data set LDS3. According to at least one embodiment, the data split condition DSC may include only the first learning data set LDS1 and the second learning data set LDS2.

The first learning data set LDS1 may include data sets classified by cluster sampling in descending order of OOD indexes DSD. For example, the first learning data set LDS1 may include first and second data sets which are cluster sampled in descending order of OOD indexes.

The second learning data set LDS2 may include data sets classified by cluster sampling in ascending order of OOD indexes ASD. For example, the second learning data set LDS2 may include first and second data sets which are cluster sampled in an ascending order of ODD indexes.

The third learning data set LDS3 may include data sets classified by random sampling RND. For example, the third learning data set LDS3 may include randomly sampled first and second data sets.

A sampling ratio between a training group, a valid group, and a test group in the first to third learning data sets LDS1, LDS2, and LDS3 may be 70(%):10(%):20(%). However, embodiments are not limited thereto. The first to third learning data sets LDS1, LDS2, and LDS3 may be provided to an algorithm group AIG.

The algorithm group AIG may include a plurality of AI algorithms AI_A, AI_B, AI_C, and AI_D. Four types of AI algorithms are shown in FIG. 12B, but embodiments are not limited thereto. The plurality of AI algorithms AI_A, AI_B, AI_C, and AI_D may learn each of the first to third learning data sets LDS1, LDS2, and LDS3.

An evaluation indicator for each of the first to third learning data sets LDS1, LDS2, and LDS3 may be extracted. Assuming that an evaluation indicator is the RMSE, the RMSE for each of the first to third learning data sets LDS1, LDS2, and LDS3 may be extracted through each of the plurality of AI algorithms AI_A, AI_B, AI_C, and AI_D. For example, for each algorithm, a test RMSE and a valid RMSE may be extracted. The test RMSE may be the RMSE for test data. The valid RMSE may be the RMSE for valid data.

A graph showing the test RMSE for each of random sampling RND, cluster sampling in descending order of OOD indexes DSD, and cluster sampling in ascending order of OOD indexes ASD is shown in FIG. 12B.

Meanwhile, the ratio between evaluation indicators for each of the test data and the valid data may be extracted. For example, the ratio of the valid RMSE to the test RMSE (“Test RMSE/Valid RMSE” shown in FIG. 12B) may be extracted for each AI algorithm. A graph showing the ratio (“Test RMSE/Valid RMSE” shown in FIG. 12B) of random sampling RND, cluster sampling in descending order of OOD indexes DSD, and cluster sampling in ascending order of OOD indexes ASD is shown in FIG. 12B.

On the other hand, the product of the test RMSE and the ratio (“Test RMSE/Valid RMSE” shown in FIG. 12B) may be calculated for each AI algorithm and each sampling method (e.g., random sampling RND, cluster sampling in descending order of OOD indexes DSD, and cluster sampling in ascending order of OOD indexes ASD). In some embodiments, from among the plurality of AI algorithms AI_A, AI_B, AI_C, and AI_D, an AI algorithm having the smallest value of the product may be selected as an optimal AI algorithm.

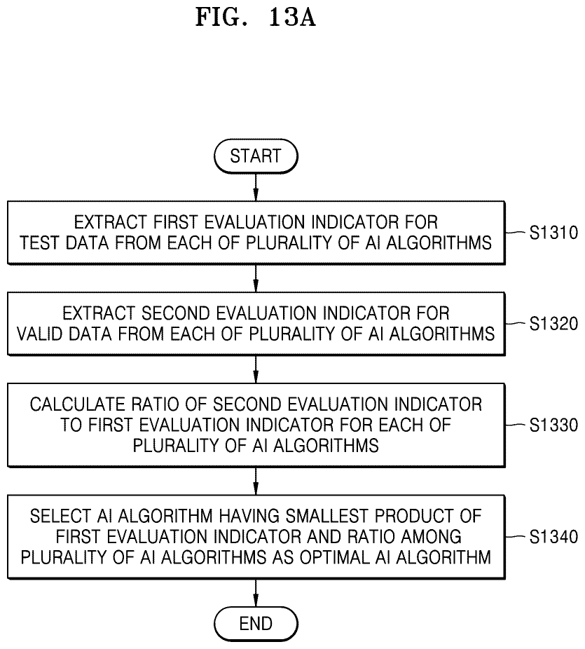

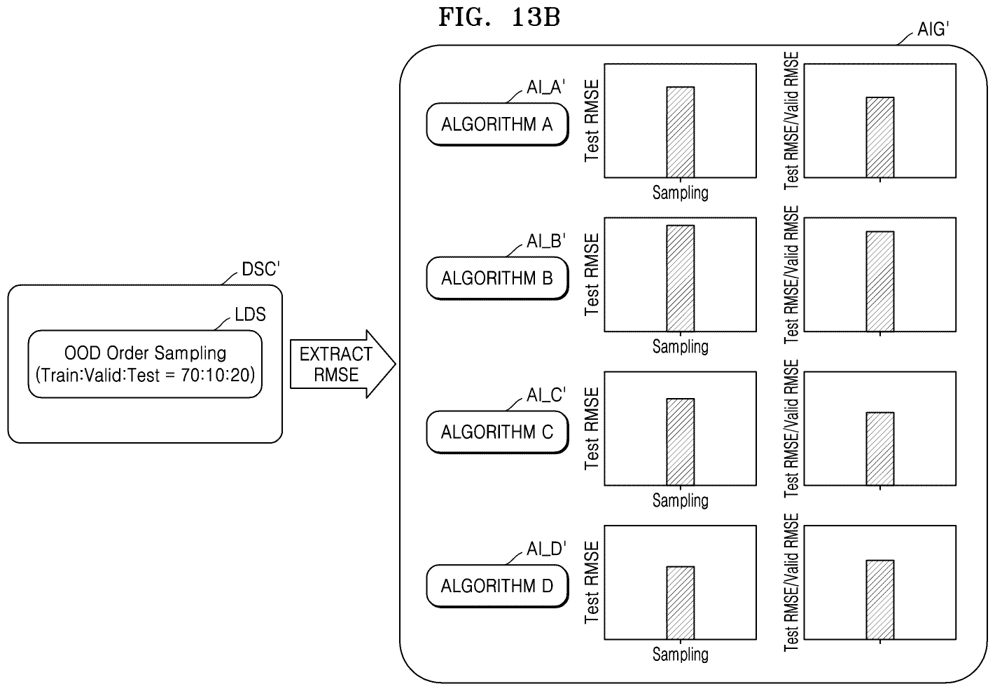

FIGS. 13A and 13B are diagrams illustrating an operation of selecting an optimal algorithm according to some embodiments.

Referring to FIG. 13A, an operation of extracting a first evaluation indicator for test data from each of a plurality of AI algorithms is performed (S1310). Here, the test data may be classified into a test group of a learning data set in first and second data sets. In this case, the learning data set may be, for example, at least one of the first to third learning data sets LDS1, LDS2, and LDS3. Hereinafter, it is assumed that the learning data set is the first learning data set LDS1 or the second learning data set LDS2. The first evaluation indicator may be, for example, a test RMSE (see “Test RMSE” in FIG. 12B).

As a specific example, in operation S1310, the first RMSE may be extracted from each of the plurality of AI algorithms by applying the test data to each of the plurality of AI algorithms.

An operation of extracting a second evaluation indicator for valid data from each of the plurality of AI algorithms is performed (S1320). Here, the valid data may be classified into a valid group of a learning data set (e.g., LDS1 or LDS2) in the first and second data sets. The second evaluation indicator may be, for example, a valid RMSE (see “Valid RMSE” in FIG. 12B).

As a specific example, operation S1320, a second RMSE may be extracted from each of the plurality of AI algorithms by applying the valid data to each of the plurality of AI algorithms.

An operation of calculating the ratio of the second evaluation indicator to the first evaluation indicator for each of the plurality of AI algorithms is performed (S1330). Here, the ratio may be represented by a formula such as “first RMSE/second RMSE” or “Test RMSE/Valid RMSE”.

An operation of selecting an AI algorithm having the smallest product of a first evaluation indicator and the ratio from among the plurality of AI algorithms as an optimal AI algorithm is performed (S1340).

Referring to FIG. 13B, a data split condition DSC′ may include the learning data set LDS. The learning data set LDS may include a data set sampled according to the order of OOD indexes. For example, the learning data set LDS may include first and second data sets which are cluster sampled in the order of OOD indexes. For example, the learning data set LDS may be the first learning data set LDS1 or the second learning data set LDS2 of FIG. 12B. A sampling ratio between the training group, the valid group, and the test group in the learning data set LDS may be 70(%):10(%):20(%). However, embodiments are not limited thereto. The learning data set LDS may be provided to an algorithm group AIG′.

The algorithm group AIG′ may include a plurality of AI algorithms AI_A′, AI_B′, AI_C′, and AI_D′. Four types of AI algorithms are shown in FIG. 13B, but embodiments are not limited thereto. The plurality of AI algorithms AI_A′, AI_B′, AI_C′, and AI_D′ may learn the learning data set LDS.

The RMSE for the learning data set LDS may be extracted through each of the plurality of AI algorithms AI_A′, AI_B′, AI_C′, and AI_D′. For example, a test RMSE and a valid RMSE for each algorithm may be extracted. The test RMSE is the RMSE for the test data and may be referred to as a first RMSE in FIG. 13A. The valid RMSE is the RMSE for the valid data and may be referred to as a second RMSE of FIG. 13A.

A graph showing the test RMSE for each algorithm is shown in FIG. 13B. Also, the ratio of the valid RMSE to the test RMSE (“Test RMSE/Valid RMSE” shown in FIG. 13B) may be extracted for each AI algorithm. A graph showing the ratio (“Test RMSE/Valid RMSE” shown in FIG. 12B) of each algorithm is shown in FIG. 13B.

Meanwhile, the product (e.g., Test RMSE*(Test RMSE/Valid RMSE)) of the test RMSE and the ratio (“Test RMSE/Valid RMSE” shown in FIG. 12B) may be calculated for each AI algorithm. An AI algorithm having the smallest value of the product may be selected as an optimal AI algorithm from among the plurality of AI algorithms AI_A′, AI_B′, AI_C′, and AI_D′.

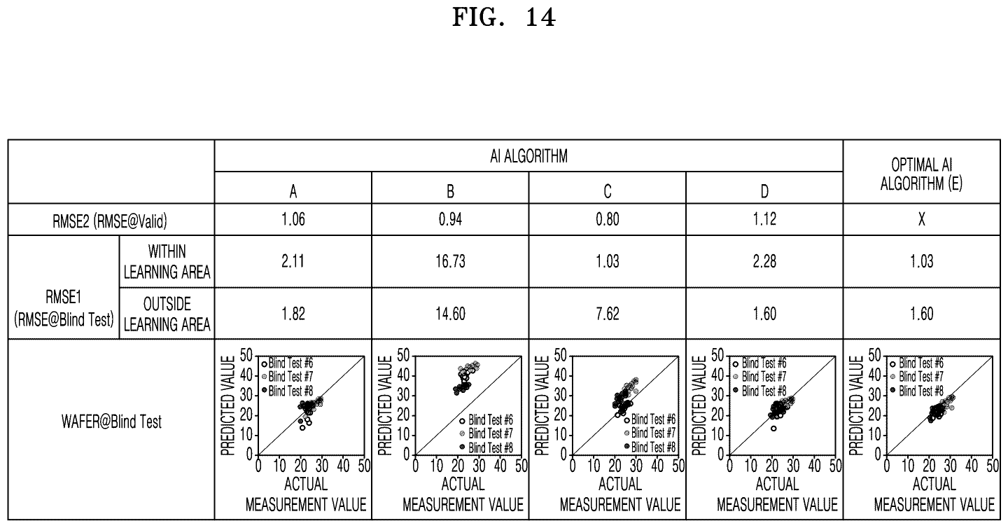

FIG. 14 is a diagram illustrating an operation of selecting an optimal algorithm according to some embodiments.

The embodiments of FIG. 14 may relate to prediction of a structure of new spectrum data beyond a learning area larger than a reference value of the existing learning data. Referring to FIGS. 7, 13A, and 14, in some embodiments, in operation S131, a first RMSE RMSE1 may be extracted within a learning area determined by an OOD index of a trained semiconductor. In addition, the first RMSE RMSE1 may be extracted outside the learning area determined by the OOD index of the trained semiconductor.

Referring to FIGS. 7 and 14, the “Blind test wafer #6”, “Blind test wafer #7”, and “Blind test wafer #8” refer to wafers to be tested (or blind tested). In this case, “Blind test wafer #6” may be included in the learning area, and “Blind test wafer #7” and “Blind test wafer #8” may be included outside the learning area. It is assumed that there are four types of AI algorithms. It is assumed that a second RMSE RMSE2 for each algorithm is extracted as 1.06, 0.94, 0.80, and 1.12. It is assumed that the first RMSE RMSE1 for each algorithm within the learning area is extracted as 2.21, 16.73, 1.03, and 2.28. It is assumed that the first RMSE RMSE1 for each algorithm outside the learning area is extracted as 1.82, 14.60, 7.62, and 1.60.

In the case of AI algorithm A, actual measurement values and predicted values of “Blind test wafer #7” and “Blind test wafer #8” may tend to be relatively more consistent than those of “Blind test wafer #6”. In the case of AI algorithm B, actual measurement values and predicted values of “Blind test wafer #6”, “Blind test wafer #7”, and “Blind test wafer #8” may tend not to be generally consistent with each other. In the case of AI algorithm C, an actual measurement value and a predicted value of “Blind test wafer #6” may tend to be relatively more consistent than those of “Blind test wafer #7” and “Blind test wafer #8”. The AI Algorithm C may be suitable for “Blind test wafer #6”. In the case of AI algorithm D, actual measurement values and predicted values of “Blind test wafer #7” and “Blind test wafer #8” may tend to be relatively more consistent than those of “Blind test wafer #6”. The AI algorithm D may be suitable for “Blind test wafer #7” and “Blind test wafer #8”.

In some embodiments, in operation S1340, according to an OOD index of the semiconductor to be predicted, a first AI algorithm having the smallest product (e.g., RMSE1*(RMSE1/RMSE2)) of the first RMSE RMSE1 and the ratio (e.g., RMSE1/RMSE2) within the learning region may be selected as the optimal AI algorithm, or a second AI algorithm having the smallest product (e.g., RMSE1*(RMSE1/RMSE2)) of the first RMSE RMSE1 and the ratio (e.g., RMSE1/RMSE2) outside the learning region may be selected as the optimal AI algorithm. The first AI algorithm having the smallest product (e.g., RMSE1*(RMSE1/RMSE2)) of the first RMSE (RMSE1) and the ratio (e.g., RMSE1/RMSE2) within the learning area may be the AI algorithm C. Also, the second AI algorithm having the smallest product (e.g., RMSE1*(RMSE1/RMSE2)) of the first RMSE RMSE1 and the ratio (e.g., RMSE1/RMSE2) outside the learning area may be the AI algorithm D. In this case, the optimal AI algorithm may be an AI algorithm E. For example, the AI algorithm C applicable within the learning area or the AI algorithm D applicable outside the learning area may be automatically selected using the OOD index value calculated for each semiconductor. Therefore, in at least one embodiment, an optimal AI algorithm is selected to identify a structure, without additional human intervention, and mitigating (or preventing) a structure from being misidentified due to OOD misclassification and/or overfitting.

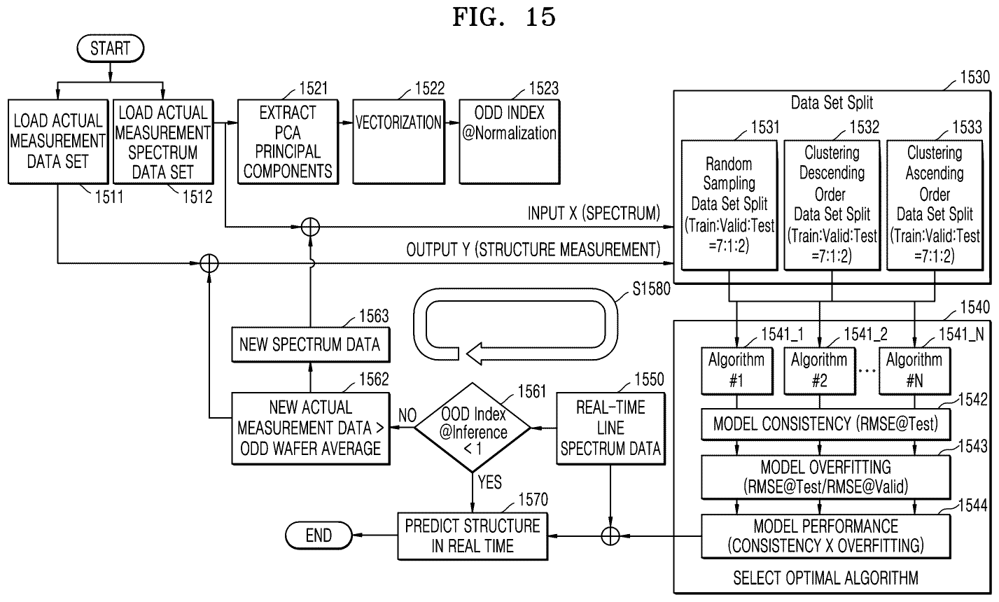

FIG. 15 is a conceptual diagram illustrating an operation method of a system according to some embodiments.

Referring to FIG. 15, the system may load an actual measurement data set (see 1511 of FIG. 15). The actual measurement data set may be a second data set. The actual measurement data set may be used in an input (see “input X (spectrum)” in FIG. 15) of an AI algorithm. The system may load an actual measurement spectrum data set (see 1512 of FIG. 15). The actual measurement spectrum data set may be a first data set. The actual measurement spectrum data set may be used in an output (see “input Y (structure measurement)” in FIG. 15) of an AI algorithm.

The system may extract a main component of the spectrum by performing PCA based on the actual measurement spectrum data set (see 1521 of FIG. 15). At least one embodiment relating to an operation of extracting the principal component of the spectrum is the same as described above with reference to FIG. 4.

The system vectorizes principal components of the spectrum extracted through PCA (see 1522 in FIG. 15). Vectors including the principal components of the spectrum are the same as shown in FIGS. 5 and 6.

The system calculates an OOD index using the vectors including the principal components of the spectrum (see 1523 in FIG. 15). At least one embodiment relating to an operation of calculating the OOD index is as the same as described above with reference to FIG. 7.

The system may perform data split using OOD indexes, the actual measurement data set, and the actual measurement spectrum data set with respect to each wafer (see 1530 of FIG. 15). A data split sampling method may include random sampling, cluster sampling in descending order of OOD index, and cluster sampling in ascending order of OOD index. According to the data split of the present disclosure, a plurality of learning data sets 1531, 1532, and 1533 may be generated. Each of the plurality of learning data sets 1531, 1532, and 1533 may include data sets classified by random sampling, cluster sampling in descending order of OOD index, and cluster sampling in ascending order of OOD index. In each sampling method, the ratio between a training group, a valid group, and a test group of the learning data set may be 7:1:2. However, embodiments are not limited thereto. At least one embodiment relating to data split is the same as described above with reference to FIGS. 9 to 11C.

The system may provide an optimal algorithm using at least one learning data set (see 1540 of FIG. 15). Here, the algorithm corresponds to the AI algorithm described above. Specifically, the system may train a plurality of algorithms 1541_1, 1541_2, and 1541_N with at least one learning data set. The number of algorithms may be N. N may be an integer of 2 or greater. The system may confirm model consistency with respect to the plurality of algorithms 1541_1, 1541_2, and 1541_N that have been trained (see 1542 of FIG. 15). Here, model consistency may be confirmed through an RMSE for test data (see “RMSE@Test” in FIG. 15). At least one embodiment relating to an operation of confirming the model consistency is the same as described above with reference to FIGS. 12A to 13B. The system may confirm model overfitting with respect to the plurality of algorithms 1541_1, 1541_2, and 1541_N that have been trained (see 1543 of FIG. 15). Here, model overfitting may be confirmed through the ratio of the second RMSE to the first RMSE (see “RMSE@Test/RMSE@Valid” in FIG. 15). At least one embodiment relating to an operation of confirming the model overfitting is the same as described above with reference to FIGS. 12A to 13B. The system may measure model performance of each of the plurality of algorithms 1541_1, 1541_2, and 1541_N that have been trained (see 1544 of FIG. 15). Here, the model performance may be confirmed through the product of model consistency and model overfitting. The system provides an algorithm having the most excellent model performance among the plurality of trained algorithms (1541_1, 1541_2, and 1541_N) as an optimal algorithm. The most excellent model performance may be the one having the smallest product of model consistency and model overfitting.

Meanwhile, the system may measure real-time line spectrum data (see 1550 in FIG. 15). The real-time line spectrum data may be part or all of spectrum data actually measured, for example, by the first measurement device 110 with reference to FIG. 1.

The system may compare the OOD index with respect to the real-time line spectrum data with a reference value (see 1561 of FIG. 15). Here, the OOD index with respect to the real-time line spectrum data is a normalized average value, and the reference value may be 1, but embodiments are not limited thereto.

When the OOD index with respect to the real-time line spectrum data is greater than the reference value (see No in 1561 of FIG. 15), the system may obtain new actual measurement data of a wafer having an OOD index greater than the reference value (see 1562 of FIG. 15). The new actual measurement data may be structure measurement data actually measured, for example, by the second measurement device 130 with reference to FIG. 1. The new actual measurement data may be merged into the actual measurement data set.

The system may obtain new spectrum data (see 1563 of FIG. 15). The new spectrum data may be, for example, spectrum data actually measured by the first measurement device 110 with reference to FIG. 1. The new spectrum data may be merged into the actual measurement spectrum data set.

When the OOD index with respect to the real-time line spectrum data is smaller than the reference value (see Yes in 1561 of FIG. 15), the system predicts the structure of a semiconductor in real time from line spectrum data through an optimal algorithm (see 1570 in FIG. 15).

An operation of predicting the structure of the semiconductor from real-time line spectrum data through the optimal AI algorithm and the operation of providing the optimal AI algorithm performed by the system may be cycled or repeated (see 1580 in FIG. 15). For example, in at least one embodiment, the operation may be included in as a first-pass confirmation for a manufactured structure, wherein real-time line spectrum is collected from manufactured semiconductor structures, and the predicted structures are compared to a planned structure. In at least one embodiment, when the planned and predicted structures are sufficiently similar (e.g., within a predetermined (or otherwise desired) tolerance), the electronic device (e.g., 120) may instruct that the manufactured structure proceed to further processing, and/or when the planned and predicted structures are sufficiently dissimilar (e.g., outside a predetermined (or otherwise desired) tolerance), the electronic device (e.g., 120) may instruct that the manufactured structure be omitted from further processing and/or that the manufactured structure be corrected.

The model overfitting may be confirmed through the ratio of the second RMSE to the first RMSE (see “RMSE@Test/RMSE@Valid” in FIG. 15). At least one embodiment relating to an operation of confirming model overfitting is the same as described above with reference to FIGS. 12A to 13B.

As described above, by selecting and providing an AI algorithm based on the OOD index of the spectrum, there may be an effect of improving the performance of a computer system configured to recognize semiconductor structures based on said spectrum, which mitigates the effects of overfitting an AI algorithm and/or algorithms to perform the same (and/or substantially similar) task.

Meanwhile, the embodiments may be implemented in the form of a recording medium storing instructions executable by a computer. Instructions may be stored in the form of program codes, and when executed by a processor, generate program modules to perform operations of the embodiments. The recording medium may be implemented as a computer-readable recording medium.

Computer-readable recording media include all types of recording media storing instructions decodable by a computer. For example, computer-readable recording media include read only memory (ROM), random access memory (RAM), magnetic tape, magnetic disk, flash memory, optical data storage device, etc.

While certain embodiments of the present disclosure have been particularly shown and described with reference to embodiments thereof, it will be understood that various changes in form and details may be made therein without departing from the spirit and scope of the present disclosure as set forth in the following claims.

1. A method of providing an artificial intelligence (AI) algorithm, the method comprising:
loading a first data set and a second data set, the first data set representing a spectrum of at least one semiconductor, and the second data set representing a structure of the at least one semiconductor;
determining an out of distribution (OOD) index with respect to the spectrum of the semiconductor for each of the at least one semiconductor based on the first data set;
performing a data split on the first data set and the second data set by cluster sampling the first data set and the second data set into at least one learning data set with respect to the OOD index according to the at least one semiconductor; and
providing an optimal AI algorithm among a plurality of AI algorithms that have been trained on the at least one learning data set.

2. The method of claim 1, wherein the determining the OOD index includes
extracting a first principal component and a second principal component, with respect to the first data set, by performing principal component analysis (PCA) to reduce a dimension of the first data set;
determining, for each of the at least one semiconductor, a value based on a Euclidean distance between vectors and a cosine distance between the vectors and an origin the vectors including the first principal component and the second principal component; and
extracting a normalized value as the OOD index by normalizing an average value of a product of the Euclidean distance and the cosine distance for each of the at least one semiconductor.

3. The method of claim 1, wherein
the at least one semiconductor includes a plurality of semiconductors, and
the performing of the data split includes sampling the first data set and the second data set at a preset ratio into a training group, a valid group, and a test group of each allocated learning data set according to the OOD indexes of the plurality of semiconductors.

4. The method of claim 3, wherein the performing of the data split includes
sampling the first data set and the second data set into the training group, the valid group, and the test group of learning data set, sequentially according to the OOD indexes of the plurality of semiconductors.

5. The method of claim 3, wherein the performing of the data split includes
sampling the first data set and the second data set into the training group, the valid group, and the test group in ascending order of increasing OOD indexes according to the plurality of semiconductors.

6. The method of claim 3, wherein
the at least one learning data set includes a first learning data set and a second learning data set, and
the performing of the data split includes
sampling the first data set and the second data set into a training group, a valid group, and a test group of the first learning data set in descending order of decreasing OOD indexes according to the plurality of semiconductors; and
sampling the first data set and the second data set into a training group, a valid group, and a test group of the second learning data set in ascending order of increasing OOD indexes according to the plurality of semiconductors.

7. The method of claim 6, wherein the providing of the optimal AI algorithm includes
extracting a first evaluation indicator for each of first valid data and first test data from each of the plurality of AI algorithms, by applying the first valid data classified into the valid group of the first learning data in the first data set and the second data set and the first test data classified into the test group of the first learning data set in the first data set and the second data set to each of the plurality of AI algorithms;
extracting a second evaluation indicator for each of second valid data and second test data from each of the plurality of AI algorithms, by applying the second valid data classified into the valid group of the second learning data set in the first data set and the second data set and the second test data classified into the test group of the second learning data set in the first data set and the second data set to each of the plurality of AI algorithms; and
selecting the optimal AI algorithm from among the plurality of AI algorithms, based on a valid root mean square error (RMSE) for the first valid data, a test RMSE for the first test data, a valid RMSE for the second valid data, and a test RMSE for the second test data.

8. The method of claim 1, wherein the providing of the optimal AI algorithm includes
extracting a first evaluation indicator, from each of the plurality of AI algorithms, by applying test data classified as a test group, of the at least one learning data set in the first data set and the second data set, to each of the plurality of AI algorithms;
extracting a second evaluation indicator from each of the plurality of AI algorithms, by applying valid data classified into a valid group, of the at least one learning data set in the first data set and the second data set, to each of the plurality of AI algorithms;
determining a ratio of the second evaluation indicator to the first evaluation indicator for each of the plurality of AI algorithms; and
selecting an AI algorithm having a smallest product of the first evaluation indicator and the ratio from among the plurality of AI algorithms as the optimal AI algorithm.

9. The method of claim 8, wherein
wherein the first evaluation indicator includes a first evaluation indicator within a learning area and a first evaluation indicator outside the learning area, and
the extracting of the first evaluation indicator includes
extracting the first evaluation indicator within the learning area determined by an OOD index of a trained semiconductor and a first evaluation indicator outside the learning area determined by the OOD index of the trained semiconductor, and
the providing of the optimal AI algorithm includes
selecting a first AI algorithm having a smallest product of the first evaluation indicator within the learning area and the ratio, and a second AI algorithm having a smallest product of the first evaluation indicator outside the learning area and the ratio as the optimal AI algorithms according to an OOD index of a semiconductor to be predicted.

10. An operation method of a computer configured to operate an artificial intelligence (AI) algorithm, the method comprising:
receiving spectrum data indicating information of an actually measured spectrum of each of a plurality of semiconductors;
generating a plurality of off of distribution (OOD) indexes by determining an OOD index for the spectrum of each of the plurality of semiconductors;
predicting, from the spectrum data and using the AI algorithm, a structure of a semiconductor, of the plurality of semiconductors, when an OOD index of the semiconductor is smaller than a reference value for the AI algorithm; and
providing an optimal AI algorithm, among a plurality of AI algorithms that have been trained, as the AI algorithm predicting the structure of the semiconductor when the OOD index of the semiconductor is greater than or equal to the reference value.

11. The method of claim 10, further comprising:
loading a first data set including the spectrum data and a second data set including structure measurement data representing information of actually measured structures of the plurality of semiconductors respectively having the plurality of OOD indexes;
calculating the plurality of OOD indexes based on the first data set; and
performing a data split on the first data set and the second data set, by cluster sampling the first data set and the second data set into at least one learning data set with respect to the OOD indexes according to the plurality of semiconductors;
wherein the optimal AI algorithm was trained on the at least one learning data set.

12. The method of claim 11, wherein the calculating of the plurality of OOD indexes includes
extracting a first principal component and a second principal component, with respect to the first data set for each of the plurality of semiconductors, by performing principal component analysis (PCA) to reduce a dimension of the first data set;
determining, a value based on a Euclidean distance between vectors and a cosine distance between the vectors and an origin, for each of the least plurality of semiconductors; and
extracting a normalized value as the OOD index, by normalizing an average value of a product of the Euclidean distance and the cosine distance for each of the plurality of semiconductors.

13. The method of claim 11, wherein
the at least one learning data set includes a first learning data set and a second learning data set, and
the performing of the data split includes
sampling the first data set and the second data set into a training group, a valid group, and a test group of the first learning data set in descending order of decreasing OOD indexes according to the plurality of semiconductors; and
sampling the first data set and the second data set into a training group, a valid group, and a test group of the second learning data set in ascending order of increasing OOD indexes according to the plurality of semiconductors.

14. The method of claim 13, wherein the providing of the optimal AI algorithm includes
extracting a first evaluation indicator for each of first valid data and first test data from each of the plurality of AI algorithms, by applying the first valid data classified into the valid group of the first learning data in the first data set and the second data set and the first test data classified into the test group of the first learning data set in the first data set and the second data set to each of the plurality of AI algorithms;
extracting a second evaluation indicator for each of second valid data and second test data from each of the plurality of AI algorithms, by applying the second valid data classified into the valid group of the second learning data set in the first data set and the second data set and the second test data classified into the test group of the second learning data set in the first data set and the second data set to each of the plurality of AI algorithms; and
selecting the optimal AI algorithm from among the plurality of AI algorithms, based on a valid root mean square error (RMSE) for the first valid data, a test RMSE for the first test data, a valid RMSE for the second valid data, and a test RMSE for the second test data.

15. The method of claim 11, wherein the providing of the optimal AI algorithm includes
extracting a first evaluation indicator from each of the plurality of AI algorithms, by applying test data classified as a test group of the at least one learning data set in the first data set and the second data set to each of the plurality of AI algorithms;
extracting a second evaluation indicator from each of the plurality of AI algorithms, by applying valid data classified into a valid group of the at least one learning data set in the first data set and the second data set to each of the plurality of AI algorithms;
determining a ratio of the second evaluation indicator to the first evaluation indicator for each of the plurality of AI algorithms; and
selecting an AI algorithm having a smallest product of the first evaluation indicator and the ratio from among the plurality of AI algorithms as the optimal AI algorithm.

16. An electronic device comprising:
a memory storing instructions for executing a method of providing an artificial intelligence (AI) algorithm; and
a processor configured to execute the instructions, wherein the processor is configured to, by executing the instructions,
load a first data set and a second data set, the first data set representing a spectrum of at least one semiconductor, and the second data set representing a structure of the at least one semiconductor,
determining an out of distribution (OOD) index with respect to the spectrum of the semiconductor for each of the least one semiconductor based on the first data set,
perform a data split on the first data set and the second data set, by cluster sampling the first data set and the second data set into at least one learning data set with respect to the OOD index according to the at least one semiconductor, and
provide an optimal AI algorithm among a plurality of AI algorithms that have been trained on the at least one learning data set.

17. The electronic device of claim 16, wherein the processor is further configured to
extract a first principal component and a second principal component, with respect to the first data set, by performing principal component analysis (PCA) to reduce a dimension of the first data set,
determine, for each of the at least one semiconductor, a value based on a Euclidean distance between vectors and a cosine distance between the vectors and an origin, the vectors including the first principal component and the second principal component, and
extract a normalized value as the OOD index, by normalizing an average value of a product of the Euclidean distance and the cosine distance for each of the at least one semiconductor.

18. The electronic device of claim 16, wherein
the at least one semiconductor includes a plurality of semiconductors, and
the processor is further configured to sample the first data set and the second data set at a preset ratio into a training group, a valid group, and a test group of each allocated learning data set according to the OOD indexes according to the plurality of semiconductors.

19. The electronic device of claim 16, wherein the processor is further configured to
extract a first evaluation indicator from each of the plurality of AI algorithms by applying test data classified as a test group of the at least one learning data set in the first data set and the second data set to each of the plurality of AI algorithms,
extract a second evaluation indicator from each of the plurality of AI algorithms by applying valid data classified into a valid group of the at least one learning data set in the first data set and the second data set to each of the plurality of AI algorithms,
determining a ratio of the second evaluation indicator to the first evaluation indicator for each of the plurality of AI algorithms, and
select an AI algorithm having a smallest product of the first evaluation indicator and the ratio from among the plurality of AI algorithms as the optimal AI algorithm.

20. The electronic device of claim 19,
wherein the first evaluation indicator includes a first evaluation indicator within a learning area and a first evaluation indicator outside the learning area, and
wherein the processor is further configured to
extract the first evaluation indicator within the learning area determined by an OOD index of a trained semiconductor,
extract the first evaluation indicator outside the learning area determined by the OOD index of the trained semiconductor, and
select a first AI algorithm having a smallest product of the first evaluation indicator within the learning area and the ratio, and a second AI algorithm having a smallest product of the first evaluation indicator outside the learning area and the ratio as the optimal AI algorithms according to an OOD index of a semiconductor to be predicted.

21.-26. (canceled)
